(19) United States
(12) Patent Application Publication
(10) Pub. No.: US 2014/0376628 A1
(43) Pub. Date: Dec. 25, 2014

(54) MULTI-VIEW IMAGE ENCODING DEVICE AND METHOD, AND MULTI-VIEW IMAGE DECODING DEVICE AND METHOD

(71) Applicant: Kabushiki Kaisha Toshiba, Minato-ku (JP)

(72) Inventors: Youhei Fukazawa, Fuchu (JP); Tomoya Kodama, Kawasaki (JP); Wataru Asano, Yokohama (JP); Tatsuya Tanaka, Kawasaki (JP)

(73) Assignee: Kabushiki Kaisha Toshiba, Minato-ku (JP)

(21) Appl. No.: 14/481,055

(22) Filed: Sep. 9, 2014

Related U.S. Application Data
(63) Continuation of application No. PCT/JP2012/001762, filed on Mar. 14, 2012.

(51) Int. Cl. H04N 19/597; H04N 19/583; H04N 19/61; H04N 19/65

(52) U.S. Cl. CPC H04N 19/00769; H04N 19/00854; H04N 19/00733; H04N 19/00781
USPC 375/240.12

(57) ABSTRACT

According to an embodiment, a multi-view image encoding device encodes a multi-view image including a plurality of viewpoint images. The device includes an assignor, a predictor, a subtractor, and an encoder. The assignor assigns reference image numbers to the reference images according to a number of reference images used in predicting already-encoded blocks obtained by dividing the viewpoint images. The predictor generates a prediction image with respect to an encoding target block obtained by dividing the viewpoint images by referring to the reference images. The subtractor calculates a residual error between an encoding target image and the prediction image. The encoder encodes: a coefficient of transformation which is obtained by performing orthogonal transformation and quantization with respect to the residual error; and the reference image numbers of the reference images used in generating the prediction image.

### CROSS-REFERENCE TO RELATED APPLICATIONS

This application is a continuation of PCT international application Ser. No. PCT/JP2012/001762 filed on Mar. 14, 2012 which designates the United States, the entire contents of which are incorporated herein by reference.

### FIELD

Embodiments described herein relates generally to a multi-view image encoding device and method, and a multi-view image decoding device and method.

### BACKGROUND

A multi-view image encoding method is known for encoding multi-view images that are used in stereoscopic pictures or free-viewpoint pictures.

There is known a conventional multi-view image encoding method in which a encoding target viewpoint image is encoded by referring to reference images that are viewpoint images which have been encoded at previous points in time.

In this multi-view image encoding method, in regard to the encoding target viewpoint image, reference images corresponding to predetermined points in time and predetermined viewpoint numbers are referred to. For that reason, it is not possible to select the most suitable reference images for the purpose of predicting the encoding target viewpoint image. As a result, encoding of a multi-view image cannot be performed in an efficient manner.

### BRIEF DESCRIPTION OF THE DRAWINGS

FIG. 1 is a block diagram illustrating a multi-view image encoding device according to a first embodiment;

FIG. 2 is a block diagram illustrating an assignor 110;

FIG. 3 is a flowchart for explaining the operations performed in the multi-view image encoding device 1;

FIG. 4 is a flowchart for explaining the operations performed by the assignor 110;

FIG. 5 is a diagram for explaining the calculation of movement information and position information of a viewpoint image;

FIG. 6 is a diagram for explaining the calculation of movement information and position information of a viewpoint image;

FIG. 7 is an explanatory diagram for explaining a reference order;

FIG. 8 is an explanatory diagram for explaining the calculation of an amount of shift as performed by a position information calculator 201;

FIG. 9 is a flowchart for explaining the operations performed by the assignor 110 according to a third embodiment;

FIG. 10 is an explanatory diagram for explaining the operations performed by the assignor 110;

FIG. 11 is an explanatory diagram for explaining the operations performed by the assignor 110 according to a modification example;

FIG. 12 is a block diagram illustrating a multi-view image decoding device 4 according to a fourth embodiment;

FIG. 13 is a block diagram illustrating an assignor 402 according to the fourth embodiment;

FIG. 14 is a flowchart for explaining the operations performed in the multi-view image decoding device 4;

FIG. 15 is a block diagram illustrating a multi-view image decoding device 5 according to a fifth embodiment;

FIG. 16 is a block diagram illustrating an assignor 501; and

FIG. 17 is a flowchart for explaining the operations performed in the multi-view image decoding device 5.

### DETAILED DESCRIPTION

According to an embodiment, a multi-view image encoding device encodes a multi-view image including a plurality of viewpoint images. The device includes an assignor, a predictor, a subtractor, and an encoder. The assignor assigns reference image numbers to the reference images according to a number of reference images used in predicting already-encoded blocks obtained by dividing the viewpoint images. The predictor generates a prediction image with respect to an encoding target block obtained by dividing the viewpoint images by referring to the reference images. The subtractor calculates a residual error between the encoding target image and the prediction image. The encoder encodes: a coefficient of transformation which is obtained by performing orthogonal transformation and quantization with respect to the residual error; and the reference image numbers of the reference images used in generating the prediction image.

### FIRST EMBODIMENT

A multi-view image encoding device 1 according to a first embodiment encodes viewpoint images included in a multi-view image, and outputs the encoded data. The multi-view image encoding device 1 can be used in, for example, a transmission device that transmits stereoscopic pictures or free-viewpoint pictures.

Each viewpoint image is associated with: time information indicating the point in time of the frame; a viewpoint number indicating the viewpoint of the viewpoint image; and prediction structure information indicating the slice type (such as an I slice, a P slice, or a B slice) used at the time of predicting the viewpoint image.

In the multi-view image encoding device 1; for each viewpoint image, position information related to the viewpoint position of the camera is obtained. Then, in the multi-view image encoding device 1; based on the position information, reference image numbers are assigned to reference images that are used in predicting the encoding target viewpoint image (hereinafter, the encoding target image). The reference image numbers can be, for example, “ref_idx” mentioned in H.264/AVC.

The multi-view image encoding device 1 refers to the reference images in order of the reference image numbers assigned to those reference images, generates a prediction image with respect to the encoding target image, and encodes the residual error between the encoding target image and the prediction image, the position information of the encoding target image, and the reference image numbers of the reference images that are used in generating the prediction image. As a result, it becomes possible to encode the multi-view image in an efficient manner.

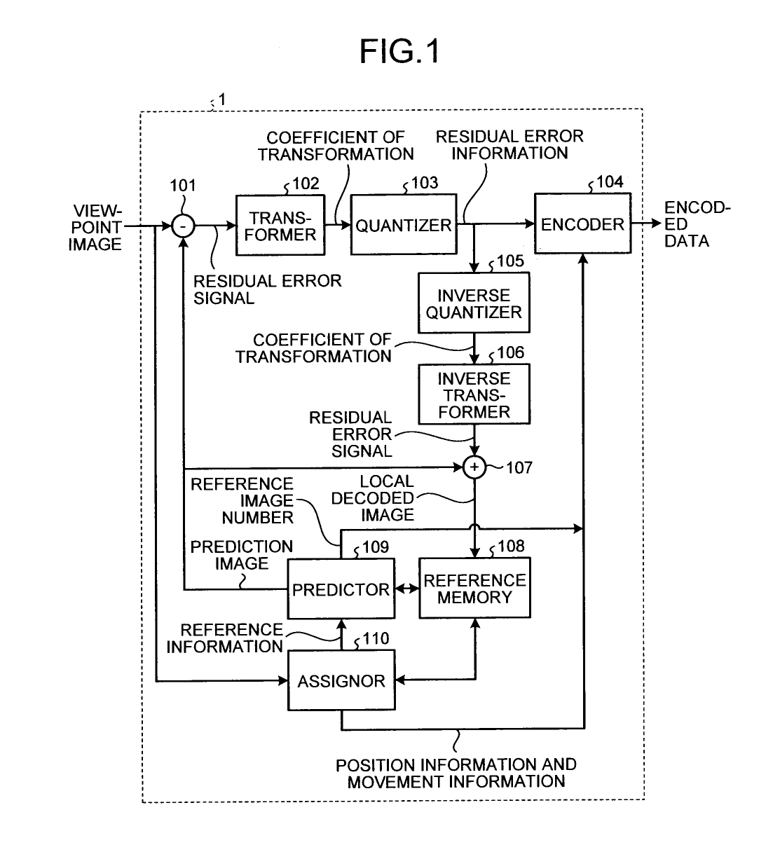

FIG. 1 is a block diagram illustrating the multi-view image encoding device 1. Herein, the multi-view image encoding device 1 includes a subtractor 101, a transformer 102, a quantizer 103, an encoder 104, an inverse quantizer 105, an inverse transformer 106, an adder 107, a reference memory 108, a predictor 109, and an assignor 110. The multi-view image encoding device 1 according to the first embodiment receives input of viewpoint images that constitute a multi-view image.

The subtractor 101 calculates a residual error signal, which represents the residual error between a viewpoint image that is input and a prediction image (described later) generated by the predictor 109. Then, the subtractor 101 sends the residual error signal to the transformer 102.

The transformer 102 performs orthogonal transformation with respect to the residual error signal, and obtains a coefficient of transformation. Then, the transformer 102 sends the coefficient of transformation to the quantizer 103. Examples of orthogonal transformation include discrete cosine transform and wavelet transform.

The quantizer 103 quantizes the coefficient of transformation and obtains residual error information. Then, the quantizer 103 sends the residual error information to the encoder 104 and the inverse quantizer 105.

The inverse quantizer 105 performs inverse quantization with respect to the residual error information and obtains the coefficient of transformation. Then, the inverse quantizer 105 sends the coefficient of transformation to the inverse transformer 106.

The inverse transformer 106 performs inverse transformation with respect to the coefficient of transformation and obtains the residual error signal. Then, the inverse transformer 106 sends the residual error signal to the adder 107.

The adder 107 adds the residual error signal and the prediction image (described later), and generates a local decoded image. Then, the adder 107 writes the local decoded image in the reference memory 108. The local decoded image that is written in the reference memory 108 serves as a reference image to be referred to by the predictor 109.

The assignor 110 assigns a reference image number to each reference image, which is stored in the reference memory 108, based on the position information of the viewpoint images and based on movement information of the viewpoint (camera) corresponding to a viewpoint image assigned with a predetermined base viewpoint number. Regarding the position information of viewpoint images and regarding the movement information of the viewpoint image assigned with the base viewpoint number, the explanation is given later.

In the first embodiment, the assignor 110 assigns the reference image number in such a manner that, closer a reference image to the encoding target image in terms of the position information, smaller is the reference image number. Then, the assignor 110 sends, to the encoder 104, the position information (described later) of the viewpoint images and the movement information (described later) of the viewpoint image assigned with the base viewpoint number. Herein, the base viewpoint number represents the viewpoint number treated as the base (such as the point of origin) at the time of calculating the position information and the movement information of the viewpoint images. Herein, the viewpoint number to be treated as the base viewpoint number can be determined in advance. Meanwhile, the assignor 110 sends, to the predictor 109, reference information that indicates the correspondence relationship between identification numbers of the reference images and the reference image numbers assigned to those reference images. Herein, the identification number can be the address in the reference memory 108 at which the reference image is written.

The predictor 109 reads the reference images from the reference memory 108 and generates a prediction image with respect to the encoding target image. Then, the predictor 109 sends the prediction image to the subtractor 101. Moreover, the predictor 109 sends, to the encoder 104, the reference image numbers that enable identification of the reference images used in generating the prediction image.

The encoder 104 encodes, in a corresponding manner, the residual error information, the reference image numbers, the position information of the viewpoint images, and the movement information of the viewpoint image assigned with the base viewpoint number, and generates encoded data. Then, the encoder 104 outputs the encoded data.

Meanwhile, the subtractor 101, the quantizer 103, the encoder 104, the inverse quantizer 105, the inverse transformer 106, the adder 107, the predictor 109, and the assignor 110 can be implemented using a central processing unit (CPU) and a memory used by the CPU. The reference memory 108 can be implemented using a memory used by the CPU or using an auxiliary memory device.

Till now, the explanation was given about the configuration of the multi-view image encoding device 1.

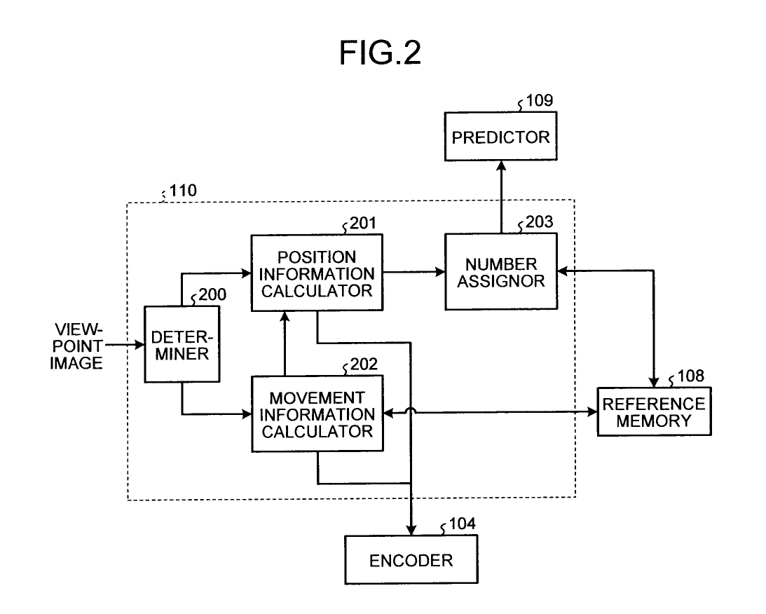

FIG. 2 is a block diagram illustrating the assignor 110 according to the first embodiment. The assignor 110 includes a determiner 200, a position information c 201, a movement information calculator 202, and a number assignor 203.

The determiner 200 determines whether the prediction structure information associated to an input viewpoint image indicates “a slice for which prediction in the time direction is not performed” (for example, the I slice) or indicates “a slice for which prediction in the time direction is performed” (for example, the P slice or the B slice).

In the first embodiment, when the prediction structure information indicates “a prediction structure in which prediction in the time direction is not performed”, the determiner 200 sends the viewpoint image to the position information calculator 201. When the prediction structure information indicates “a prediction structure in which prediction in the time direction is performed”, the determiner 200 sends the viewpoint image to the movement information calculator 202.

The position information calculator 201 calculates the position information of the viewpoint image corresponding to each viewpoint number at the same point in time. At that time, the position information calculator 201 can hold each viewpoint image that is input frame by frame, and can calculate the position information of the viewpoint image corresponding to each viewpoint number from the viewpoint image assigned with the base viewpoint number. Then, the position information calculator 201 sends the calculated position information of each viewpoint image to the encoder 104 and the number assignor 203 (described later).

The movement information calculator 202 refers to the viewpoint images and to the reference images stored in the reference memory 108, and accordingly calculates the movement information of the viewpoint image assigned with the base viewpoint number. The movement information indicates the extent by which the position information of the viewpoint image assigned with the base viewpoint number has moved from a base point in time. Then, the movement information calculator 202 sends the calculated movement information to the number assignor 203 and the encoder 104.

The number assignor 203 assigns a reference image number to each reference image, which is stored in the reference memory 108, based on the position information of the viewpoint images and based on the movement information of the viewpoint (camera) corresponding to the viewpoint image assigned with the base viewpoint number.

Till now, the explanation was given about the configuration of the assignor 110.

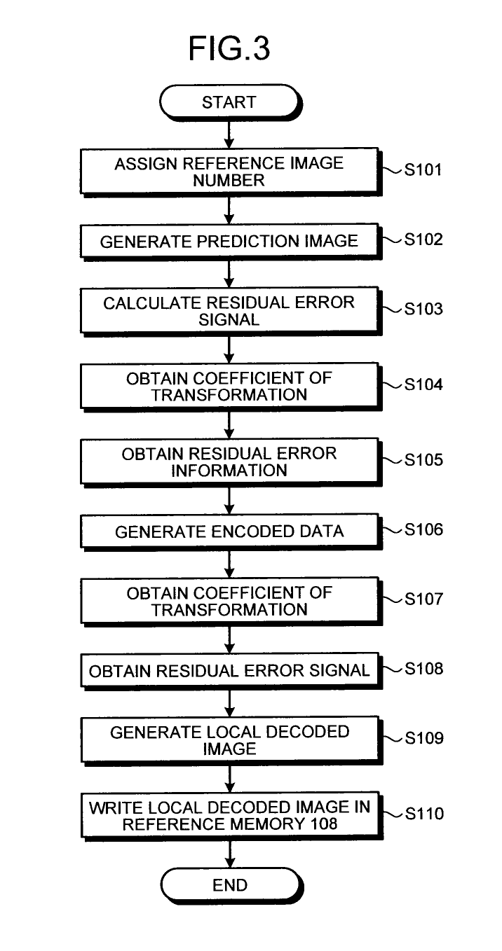

FIG. 3 is a flowchart for explaining the operations performed in the multi-view image encoding device 1. The assignor 110 assigns a reference image number to each reference image based on the position information of the viewpoint images and based on the movement information of the viewpoint (camera) corresponding to a viewpoint image assigned with a predetermined base viewpoint number (S101).

The predictor 109 reads the reference images from the reference memory 108 and generates a prediction image with respect to the encoding target image (S102). Then, the predictor 109 sends the prediction image to the subtractor 101. Moreover, the predictor 109 sends, to the encoder 104, the reference image numbers of the reference images used in generating the prediction image.

The subtractor 101 calculates a residual error signal that represents the residual error between the obtained viewpoint image and the prediction image generated by the predictor 109 (S103). Then, the subtractor 101 sends the residual error signal to the transformer 102.

The transformer 102 performs orthogonal transformation with respect to the residual error signal and obtains a coefficient of transformation (S104). Then, the transformer 102 sends the coefficient of transformation to the quantizer 103.

The quantizer 103 quantizes the coefficient of transformation and obtains residual error information (S105). Then, the quantizer 103 sends the residual error information to the encoder 104 and the inverse quantizer 105.

The encoder 104 encodes, in a corresponding manner, the residual error information, the reference image numbers, the position information of the viewpoint images, and the movement information of the viewpoint image assigned with the base viewpoint number, and generates encoded data (S106). Then, the encoder 104 outputs the encoded data.

The inverse quantizer 105 performs inverse quantization with respect to the residual error information and obtains the coefficient of transformation (S107). Then, the inverse quantizer 105 sends the coefficient of transformation to the inverse transformer 106.

The inverse transformer 106 performs inverse transformation with respect to the coefficient of transformation and obtains the residual error signal (S108). Then, the inverse transformer 106 sends the residual error signal to the adder 107.

The adder 107 adds the residual error signal and the prediction image, and generates a local decoded image (S109). Then, the adder 107 writes the local decoded image as a reference image in the reference memory 108 (S110).

The multi-view image encoding device 1 performs the operations starting from Step S101 to Step S110 in a repeated manner until the input of viewpoint images ends.

Till now, the explanation was given about the operations performed in the multi-view image encoding device 1.

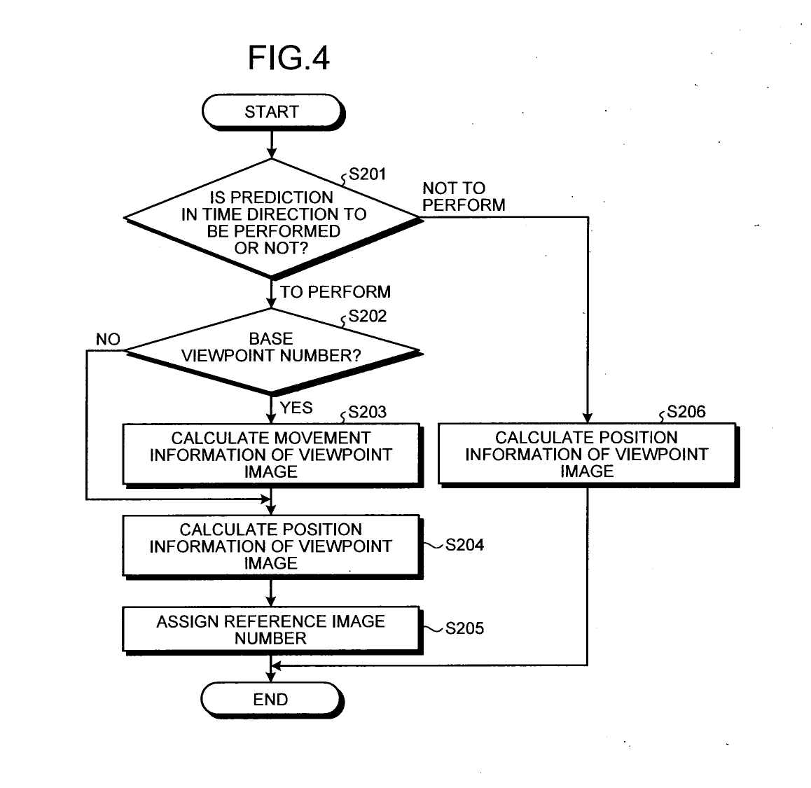

Given below is explanation of the operations performed by the assignor 110 according to the first embodiment. At Step S201 in FIG. 4, the determiner 200 determines whether the prediction structure information associated to the encoding target image indicates “a slice for which prediction in the time direction is not performed” or indicates “a slice for which prediction in the time direction is performed” (S201).

In the first embodiment, if the prediction structure information indicates “a slice for which prediction in the time direction is not performed”, the determiner 200 sends the viewpoint image to the position information calculator 201. If the prediction structure information indicates “a slice for which prediction in the time direction is performed”, the determiner 200 sends the viewpoint image to the movement information calculator 202.

If it is determined that prediction in the time direction is to be performed (to perform at S201), the movement information calculator 202 determines whether the viewpoint number of the encoding target image is the base viewpoint number (S202).

If the viewpoint number of the encoding target image is the base viewpoint number (YES at S202), the movement information calculator 202 calculates the movement information of the encoding target image (S203). For example, if the encoding target image is a viewpoint image assigned with the base viewpoint number at a point in time t1, the movement information calculator 202 refers to the reference memory 108 and obtains the position information of the viewpoint image assigned with the base viewpoint number at a point in time t0. Then, the movement information calculator 202 obtains movement information Dₜ₁ₜ₀ that indicates the extent by which the position of the encoding target image at the point in time t1 moved from the position of the viewpoint image assigned with the base viewpoint number at the point in time t0. For example, the movement information can be expressed in the form of a vector indicating the distance and the direction of the movement.

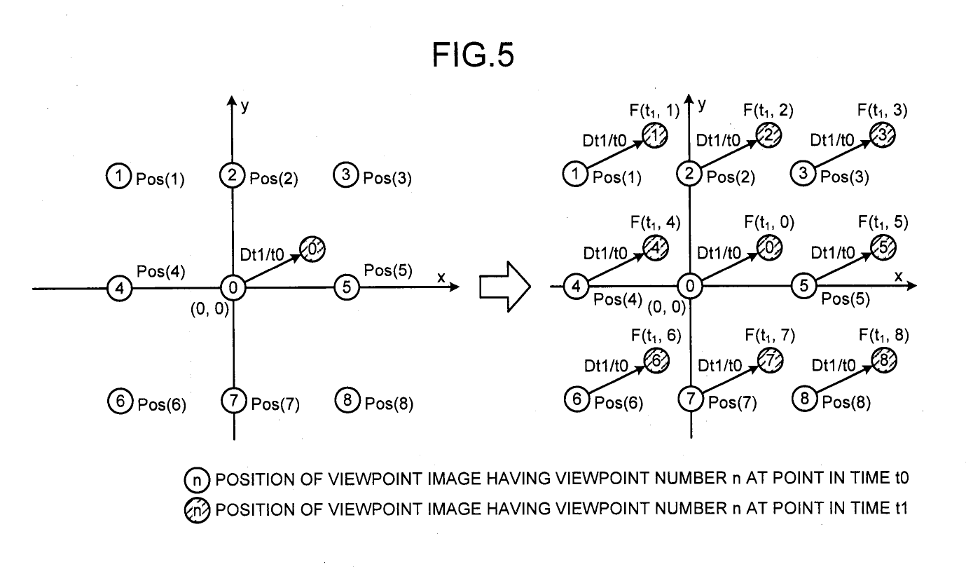

At Step S204, the position information calculator 201 calculates the position information of each viewpoint image at the same point in time (S204). FIG. 5 is a diagram for explaining the calculation of the movement information and the position information of a viewpoint image. For example, assume that, with respect to the viewpoint image assigned with the base viewpoint number (such as a viewpoint number “0”), the viewpoint image assigned with a viewpoint number “k” has the relative position Pos(k). Herein, k=1, 2, 3, . . . , (N−1) is satisfied, and N represents the number of viewpoints. Thus, a multi-view image includes the viewpoint images starting from the viewpoint image having the viewpoint number “0” to the viewpoint images having the viewpoint number “k” (K=1 to (N−1)). The movement information of the viewpoint image assigned with the base viewpoint number (the viewpoint number “0”) between the point in time t0 and the point in time t1 is represented as Dₜ₁ₜ₀.

In the case of a normal multi-view camera capable of taking multi-view images, it is often the case that the relative positions between the cameras are fixed. For that reason, the distance from the position of the camera that takes the viewpoint image assigned with the base viewpoint number to each other camera that takes the viewpoint image having the viewpoint number “k” can be expressed as Pos(k). Thus, at the point in time t1, position information f(t1,k) of the viewpoint number (k) can be expressed using Equation (1) given below.

F(t₁,k)=Pos(k)+Dₜ₁ₜ₀ (1)

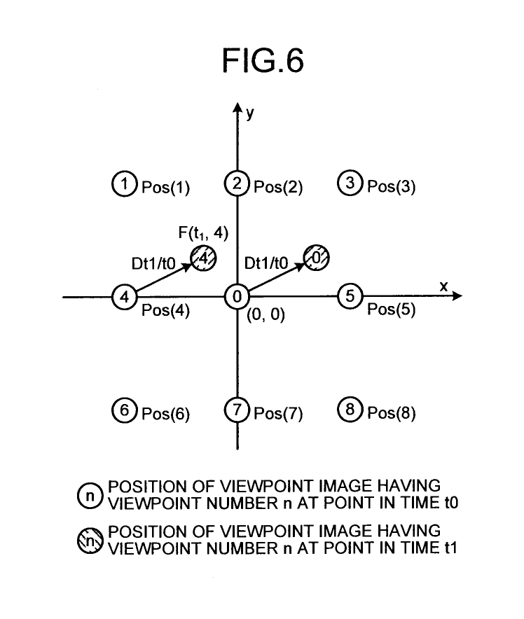

In this way, the position information calculator 201 calculates the position information of the viewpoint images. FIG. 6 is a diagram for explaining the calculation of the movement information and the position information of viewpoint images using a specific example.

For example, as illustrated in FIG. 6, when viewpoint images are taken by a camera having nine viewpoints and when the position of Pos(4) is (−4, 0) and Dₜ₁ₜ₀ is (3, 1), the position information calculator 201 obtains (−1, 1) using Equation (1) as the position of the viewpoint image having the viewpoint number 4 at the point in time t1.

Meanwhile, if the viewpoint number of the encoding target image is not the base viewpoint number (NO at S202); the system control proceeds to Step S204.

At Step S205, the number assignor 203 assigns reference image numbers to the reference images based on the position information of the viewpoint images and based on the movement information of the viewpoint image assigned with the base viewpoint number (S205). In the first embodiment, the number assignor 203 compares the position information of the reference images stored in the reference memory 108 with the position information of each viewpoint image obtained at Step S204, and sequentially assigns the reference image numbers starting from the reference image having the closest position information to the viewpoint image.

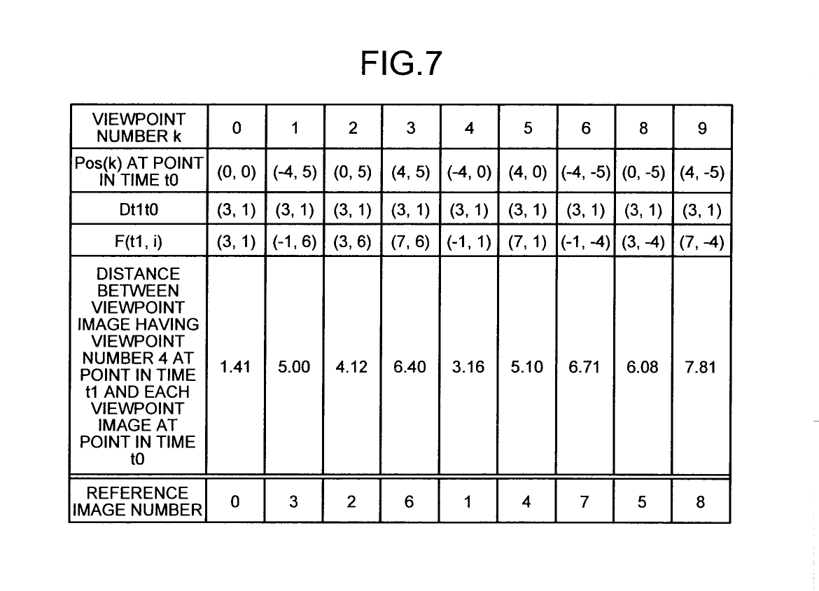

FIG. 7 is an explanatory diagram for explaining the reference order decided by the number assignor 203. In FIG. 7 is illustrated the reference order of the reference images that are supposed to be referred to by the predictor 109 in the case in which the viewpoint image having the viewpoint number “4” at the point in time t1 is the encoding target image.

In this example, it is assumed that the viewpoint images having the viewpoint numbers “0” to “8” at the point in time t0 are stored in the reference memory 108. In this case, as illustrated in FIG. 7, shorter the distance from a reference image to the viewpoint image having the viewpoint number “4” at the point in time t1, smaller is the reference image number (such as ref_idx) assigned to that reference image by the number assignor 203.

Meanwhile, if reference images having identical position information with respect to a viewpoint image are stored in the reference memory 108, the number assignor 203 assigns the reference image number in such a manner that, closer a reference image to the viewpoint image in terms of the point of time, smaller can be the reference image number.

Moreover, if reference images having identical position information and an identical point in time with respect to a viewpoint image are stored in in the reference memory 108, the number assignor 203 can assign the reference image number in such a manner that, smaller the viewpoint number of a reference image, smaller is the reference image number.

Then, the number assignor 203 sends, to the predictor 109, reference information in which the reference image numbers assigned to the reference images and the identification numbers of the reference images are held in a corresponding manner. That marks the end of the operations.

At Step 201, if it is determined that prediction in the time direction is not performed (not to perform at S201), then, at Step S206, the position information calculator 201 calculates the position information of each viewpoint image using the viewpoint image that has been input (S206).

Till now, the explanation was given about the operations performed by the assignor 110 according to the first embodiment.

According to the first embodiment, the reference image numbers are assigned to the reference images using the position information of the viewpoint image corresponding to each viewpoint number and using the movement information of the viewpoint image assigned with the base viewpoint number. As a result, it becomes possible to select the most suitable reference images for the purpose of predicting the encoding target viewpoint image. That enables achieving enhancement in the encoding efficiency.

Meanwhile, if the relative positions among viewpoint cameras are not fixed, then the position information calculator 201 can obtain the position information of the viewpoint images at each point in time and send the position information to the number assignor 203.

Moreover, if the reference images stored in the reference memory 108 correspond to a plurality of points in time, the position information calculator 201 can treat the position information of the viewpoint image assigned with the base viewpoint number at the point in time t0 as the starting point and go on adding the movement information of the viewpoint image assigned with the base viewpoint number calculated at each subsequent point in time, and can obtain the position information of the viewpoint image corresponding to all viewpoint numbers at all points in time.

Furthermore, in order to achieve reduction in the throughput, the movement information calculator 202 can set a predetermined distance “R” and, when the distance between the processing target viewpoint image and a reference image exceeds the distance R, can skip referring to the subsequently-present reference images.

### Specific Example of Step S206

At Step S206 illustrated in FIG. 4, the position information calculator 201 can calculate the position information of each viewpoint image in the following manner.

When the viewpoint image (called V0) corresponding to the base viewpoint number is treated as the starting point, the position information calculator 201 calculates the position information Pos(k) of the other viewpoint images (called Vk (k=1, 2, 3, . . . , M−1) (M represents the number of viewpoints)). That is, as the position information Pos(k), the position information calculator 201 obtains the “amount of shift” representing the shift of the viewpoint image Vk with respect to the viewpoint image the viewpoint image V0.

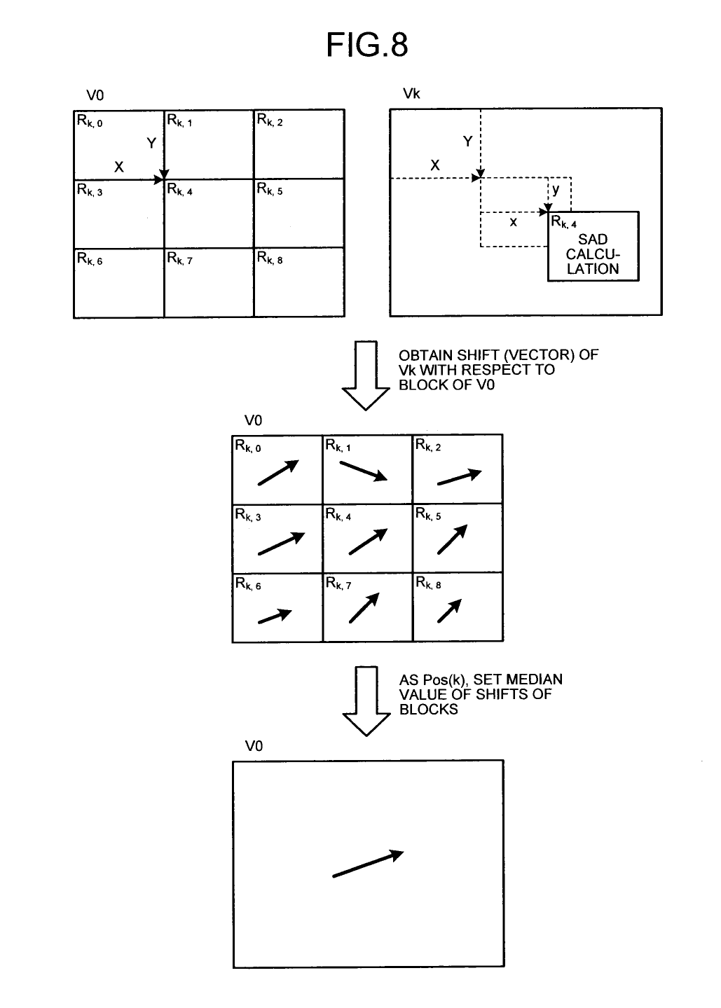

FIG. 8 is an explanatory diagram for explaining the calculation of the amount of shift as performed by the position information calculator 201. As illustrated in FIG. 8, the position information calculator 201 divides the viewpoint image Vk into a plurality of blocks. Then, the position information calculator 201 calculates the amount of shift (R_{k, 0}, R_{k, 1}, R_{k, 2}, . . . , R_{k, N-1}, where N represents the number of blocks) on a block-by-block basis, and sets the median value of the amounts of shift among the blocks as the amount of shift of the viewpoint image Vk with respect to the viewpoint image V0.

Given below is the explanation of a method of obtaining the amounts of shift among the blocks when the number of divisions is equal to nine. With respect to each block, the position information calculator 201 calculates, using Equation (2), SAD_{k, j} (sum of absolute difference) as the cost of the shift with respect to the viewpoint image V0.

$${SAD}_{k , j} ( x , y ) = {\sum }_{{0 \leq w \leq {W}_{p}}_{0 \leq h \leq {H}_{p}}}^{ } \vert {Y}_{V 0} ( X + w , Y + h ) - {Y}_{Vk} ( X + x + w , Y + y + h ) \vert ( 0 \leq x \leq {W}_{k} , 0 \leq y \leq {H}_{k} ) \qquad ( 2 )$$

Herein, “j” represents the block number. When there are nine parallaxes, j=0, 1, 2, . . . , 8 is satisfied. Moreover, “k” represents the viewpoint number. Furthermore, Y_{V0} (a, b) represents the luminance value of the pixel at coordinates (a, b) in the viewpoint image V0. Similarly, Y_{Vk} (a, b) represents the luminance value of the pixel at the coordinates (a, b) in the viewpoint image Vk. Moreover, Wₚ represents the block width. Furthermore, Hₚ represents the block height. Moreover, “X” and “Y” represent the upper left coordinates of each block in the viewpoint image V0. Furthermore, “w” represents a variable that satisfies 0≦w≦Wₚ. Moreover, h represents a variable that satisfies ≦h≦Hp. Furthermore, Wₖ represents the width of the viewpoint image Vk. Moreover, Hₖ represents the height of the viewpoint image Vk.

The position information calculator 201 uses Equation (3) and obtains a vector R_{k, j}=(u, v) for which the calculated SAD_{k, j} is the smallest.

R_{k,j}=(u,v)=(arg minₓ(SAD_{k,j}(x,y)),arg min_{y}(SAD_{k,j}(x,y))) (0≦x≦Wₖ,0≦y≦Hₖ) (3)

The position information calculator 201 obtains the median value of the amounts of shift R_{k, j} of all blocks as the amount of shift of the viewpoint image Vk with respect to the viewpoint image V0. With that, it becomes possible for the position information calculator 201 to obtain the Pos(k) of the viewpoint image Vk with respect to the viewpoint image V0.

### Specific Example of Step S203

At Step S203 illustrated in FIG. 4, the movement information calculator 202 can calculate the movement information Dₜ₁ₜ₀ in the following manner.

When the viewpoint image (called V0t1) corresponding to the base viewpoint at the point in time t1 is the encoding target image, the movement information calculator 202 divides the viewpoint image V0t1 into blocks in an identical manner to the first modification example and obtains the median value of the amounts of shift between the corresponding blocks in the encoding target image V0t1 and the reference image V0t0. Then, the movement information calculator 202 sets the obtained median value as the movement information Dₜ₁ₜ₀ of the viewpoint image (V0t1) assigned with the base viewpoint number.

Meanwhile, regarding the means of calculating a global movement, the viewpoint image assigned with the base viewpoint number and the reference image having the same viewpoint number may not be used. Moreover, in order to achieve reduction in the throughput, it is possible to perform partial image trimming, overall image sub-sampling, or reduction using average values.

In the first embodiment, a viewpoint image is divided into nine blocks. However, that is not the only possible case. Moreover, in each block obtained by dividing a viewpoint image, cost calculation is performed using the sum of absolute difference (SAD). However, alternatively, the cost calculation can be performed using the sum of squared differences (SSD).

Furthermore, the movement vector obtained in each block is not limited to the median value. Alternatively, it is also possible to use the average value as the movement vector. Moreover, while obtaining the movement of the viewpoint image assigned with the base viewpoint number or obtaining the position information of each viewpoint image, the depth may also be taken into account. Regarding the pixels having the depth equal to or more than a predetermined value, changes can be made about whether or not to make use of the SAD cost.

Furthermore, herein, the direction of movement of the viewpoints is assumed to be on a plane. However, if information indicating the distance of an object from a viewpoint such as the depth is used, it is also possible to deal with the case in which the viewpoints move in the front-back direction. Moreover, even in the case in which the position of a viewpoint is moved back and forth, it is possible to make use of the information indicating the distance from the viewpoint position to an object. Furthermore, any viewpoint number can be treated as the base viewpoint number, and there is no limitation on the number of viewpoints.

In this way, by calculating the inter-viewpoint amount of displacement from image information, it becomes possible to obtain the positional relationship between the viewpoint images and to obtain the movement information of the viewpoint image assigned with the base viewpoint number. Hence, it becomes possible to achieve enhancement in the encoding efficiency.

### SECOND EMBODIMENT

A multi-view image encoding device 2 according to a second embodiment differs from the first embodiment in the way that the position information and the movement information of the viewpoint images is obtained using camera parameters of the cameras used in taking the multi-view images. In the second embodiment, the camera parameters include camera position information and camera acceleration of each camera that takes a viewpoint image. Herein, the camera acceleration can be measured using an acceleration sensor.

As compared to the multi-view image encoding device 1 according to the first embodiment, the multi-view image encoding device 2 mainly differs in the way that camera parameter information is added to the input viewpoint images and mainly differs in the operations performed by the position information calculator 201 and the movement information calculator 202.

The multi-view image encoding device 2 has an identical configuration to the configuration illustrated in FIG. 1 and FIG. 2. Hence, the explanation thereof is not repeated. Moreover, the overall sequence of operations of the multi-view image encoding device 2 is identical to the sequence of operations illustrated in FIG. 3 and FIG. 4. Hence, the explanation thereof is not repeated.

Given below is the explanation of the differences in the operations performed by the position information calculator 201 and the movement information calculator 202 according to the second embodiment as compared to the first embodiment.

At Step S206 illustrated in FIG. 4, the position information calculator 201 refers to the camera position information included in the camera parameters that are added to an input viewpoint image, and accordingly calculates the position information Pos(k) of that viewpoint image.

At Step S203 illustrated in FIG. 4, the movement information calculator 202 refers to the camera acceleration included in the camera parameters that are added to an input viewpoint image, and accordingly calculates the movement information Dₜ₁ₜ₀ of the viewpoint image assigned with the base viewpoint number.

In the second embodiment, the camera parameters may be set by a user at the time of taking the multi-view images, or may be externally provided instead of adding them to the viewpoint images.

According to the second embodiment, as a result of using the camera parameters of the cameras used in taking multi-view images, it becomes possible to obtain a more accurate positional relationship among the viewpoint images and to obtain more accurate movement information of the viewpoint image assigned with the base viewpoint number. Hence, it becomes possible to perform encoding with more efficiency.

Meanwhile, the positional relationship among the viewpoints and the movement information of the viewpoint image assigned with the base viewpoint number explained in the first and second embodiments can be implemented in combination too.

For example, the positional relationship among the viewpoint images can be provided from outside as explained in the second embodiment, while the movement information of the viewpoint image assigned with the base viewpoint number can be calculated by means of block matching as explained in the first embodiment.

### THIRD EMBODIMENT

A multi-view image encoding device 3 according to a third embodiment can be suitably implemented in the case in which the encoding target viewpoint image (the encoding target image) is encoded on a block-by-block basis. In the multi-view image encoding device 3, the reference image numbers that are to be assigned to the reference images, which are used in predicting the encoding target block, are decided from the reference images used by the already-encoded blocks present around the encoding target block. Meanwhile, the multi-view image encoding device 3 has an identical configuration to the configuration illustrated in FIG. 1. Hence, the explanation thereof is not repeated. Moreover, the blocks mentioned in the third embodiment can be macro blocks too.

In the multi-view image encoding device 3, the operation performed at Step S101 in the flowchart illustrated in FIG. 3 is different than the embodiments described above.

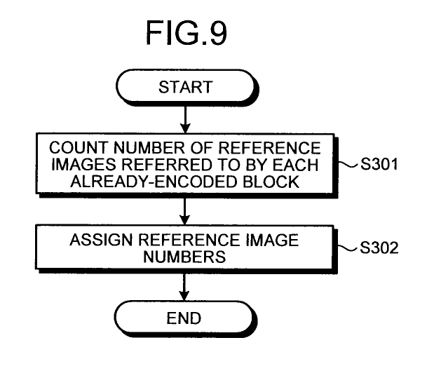

FIG. 9 is a flowchart for explaining the operations performed by the assignor 110 according to the third embodiment. The flowchart illustrated in FIG. 9 corresponds to the internal operations performed at Step S101.

At Step S301, in the encoding target image, the assignor 110 counts, for each identification number, the number of reference images that have been referred to by the already-encoded blocks present around the encoding target block (S301). The assignor 110 can hold the identification numbers of the reference images in a corresponding manner to the count numbers. Then, every time the reference image having a particular identification number is counted, the assignor 110 can update the corresponding count number.

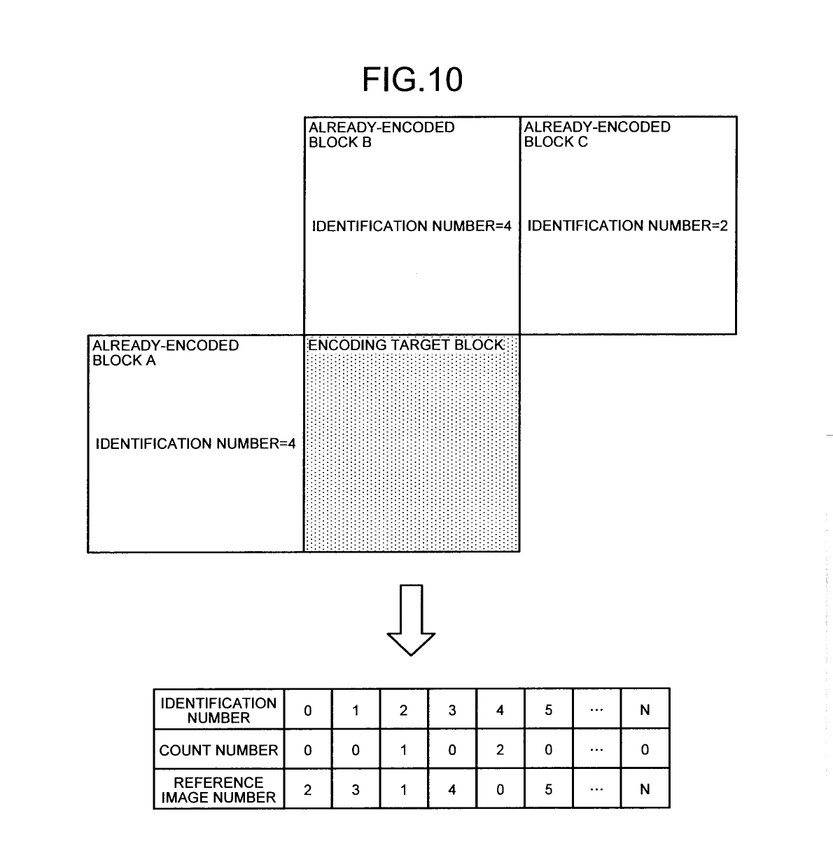

FIG. 10 is an explanatory diagram for explaining the operations performed by the assignor 110 according to the third embodiment. In the example illustrated in FIG. 10, it is assumed that already-encoded blocks A, B, and C are present around the encoding target block. The block A is predicted from the reference image having a reference image number “4”. The block B is predicted from the reference image having a reference image number “2”. The block C is predicted from the reference image having the reference image number “4”.

The assignor 110 counts, for each reference image number, the reference images that are referred to by the already-encoded blocks present around the encoding target block (i.e., the blocks A, B, and C). In the example illustrated in FIG. 10, regarding the reference image numbers that enable identification of the reference images corresponding to the blocks A, B, and C, it is the reference image number “4” for the block A, the reference image number “4” for the block B, and the reference image number “2” for the block C. For that reason, regarding the reference images counted by the assignor 110, the reference images, having the reference image number “4” are counted twice, the reference images having the reference image number “2” are counted once, and the other reference images are counted for zero times.

At Step S302, greater the count number for a reference image, smaller is the reference image number assigned to that reference image by the assignor 110.

In the example illustrated in FIG. 10, regarding the count numbers of the reference images, since the reference images having the reference image number “4” are counted twice and the reference images having the reference image number “2” are counted once, the assignor 110 assigns a reference image number “0” to the reference image having the reference image number “4”. Moreover, the assignor 110 assigns a reference image number “1” to the reference image having the reference image number “2”.

Meanwhile, regarding other reference images which have the same count number for other reference image numbers, the assignor 110 can assign the reference image numbers according to a predetermined method. In the example illustrated in FIG. 10, smaller the identification number of a reference image, smaller is the reference image number assigned to that reference image.

At that time, in the case of reference images having the same count number, closer a reference image to the encoding target image in terms of the point of time, smaller can be the reference image number assigned to that reference image. If the point in time is also same, the reference image numbers in that viewpoint can be decided according to the original reference order of the reference images.

### Modification Example

In the third example, a reference image number is assigned by counting the reference images that have been referred to by the already-encoded blocks present around the encoding target block. However, the method of assigning the reference image numbers is not limited to that method.

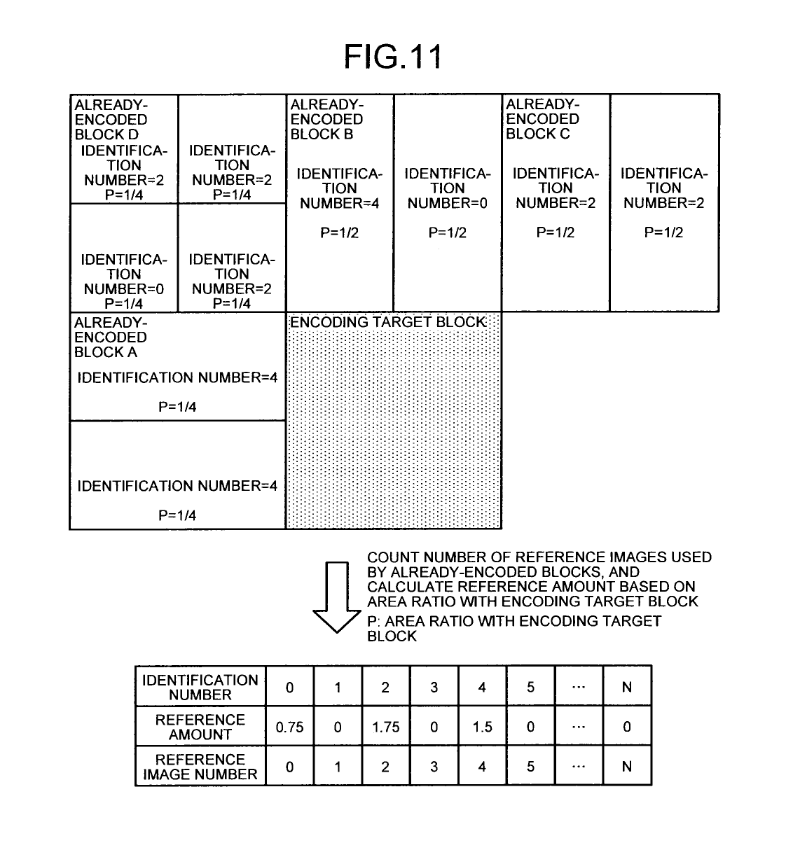

FIG. 11 is an explanatory diagram for explaining the operations performed by the assignor 110 according to a modification example of the third embodiment. As illustrated in FIG. 11, to the count number of the reference images that are referred to by the already-encoded blocks (for example, blocks A, B, C, and D), the assignor 110 multiplies a weight W based on the block size and calculates a reference amount to be used for assigning the reference image numbers. The weight W can be obtained using Equation (4).

W=(Area of already-encoded blocks)/(Area of encoding target block) (4)

Then, greater the calculated reference amount for a reference image, smaller is the reference image number assigned to that reference image by the assignor 110.

In the modification example, the assignor 110 calculates the weight W based on the block size. However, alternatively, based on the distances between the encoding target block and the already-encoded blocks or based on the shapes of the blocks, the blocks not adjacent to the encoding target block or the blocks having different shapes than the shape of the encoding target block can be set to have “0” as the weight W. On the other hand, regarding the blocks adjacent to the encoding target block and having the same shape as the shape of the encoding target block, the weight W can be calculated to be a higher value.

Moreover, in the third embodiment, such reference images are counted which are referred to by the already-encoded blocks present in the encoding target images having the same viewpoint and the same point in time. However, that is not the only possible case. That is, the already-encoded blocks that refer to the reference image numbers need not have the same point in time and the same viewpoint. Thus, it is also possible to use the reference image numbers that are referred to by the already-encoded blocks present at the same positions at different points in time but with the same viewpoint. Alternatively, it is also possible to use the reference image numbers that are referred to by the already-encoded blocks having different viewpoints and different points in time. Still alternatively, it is also possible to use the reference image numbers that are referred to by the already-encoded blocks present on the left side/on top/on the upper left side/on the upper left side of the encoding target block.

Meanwhile, if the count number of the reference images that are referred to by each already-encoded block is same, then, closer a reference image to the encoding target image in terms of point in time, smaller can be the reference image number assigned to that reference image. Alternatively, closer a reference image to the encoding target image in terms of the viewpoint number, smaller can be the reference image number assigned to that reference image.

Thus, according to the third embodiment, it becomes possible to perform encoding in an efficient manner while holding down the amount of encoding.

### FOURTH EMBODIMENT

A multi-view image decoding device 4 according to a fourth embodiment decodes the encoded data that has been encoded in the multi-view image encoding device 1 according to the first embodiment or the multi-view image encoding device 2 according to the second embodiment.

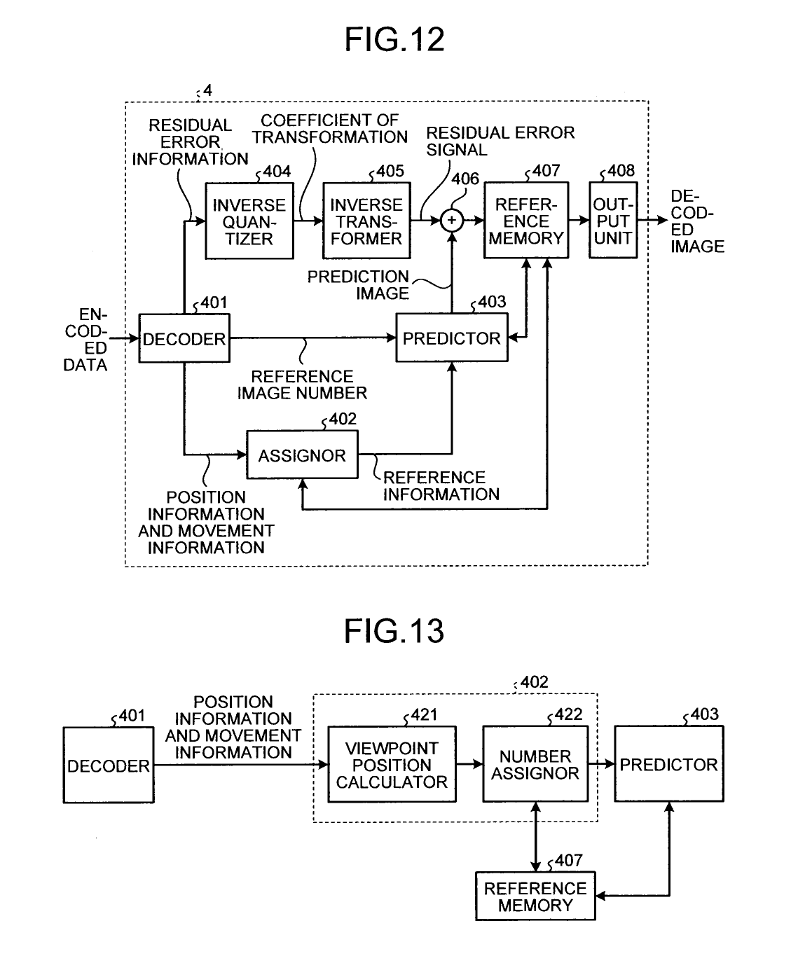

FIG. 12 is a block diagram illustrating the multi-view image decoding device 4. Herein, the multi-view image decoding device 4 includes a decoder 401, an assignor 402, a predictor 403, an inverse quantizer 404, an inverse transformer 405, an adder 406, a reference memory 407, and an output unit 408.

The encoded data input to the multi-view image decoding device 4 contains: residual error information of a prediction image with respect to a viewpoint image; the position information related to the viewpoint positions of cameras corresponding to the viewpoint images; reference image numbers of the reference images used in generating the prediction image; and movement information of the viewpoint image assigned with the base viewpoint number.

The decoder 401 decodes the input encoded data into residual error information, position information, and reference image numbers.

Then, the decoder 401 sends, to the assignor 402, the position information of the viewpoint images and the movement information of the viewpoint image assigned with the base viewpoint number. Moreover, the decoder 401 sends the residual error information to the inverse quantizer 404. Furthermore, the decoder 401 sends the reference image numbers to the predictor 403.

The inverse quantizer 404 performs inverse quantization with respect to the residual error information and obtains a coefficient of transformation. Then, the inverse quantizer 404 sends the coefficient of transformation to the inverse transformer 405.

The inverse transformer 106 performs inverse transformation with respect to the coefficient of transformation and obtains a residual error signal. Then, the inverse transformer 405 sends the residual error signal to the adder 406.

The assignor 402 refers to the movement information of the viewpoint image assigned with the base viewpoint number, and assigns reference image numbers to the reference images used by the predictor 403 in generating a prediction image. Then, the assignor 402 sends, to the predictor 403, reference information that indicates the correspondence relationship between identification numbers of the reference images and the reference image numbers assigned to those reference images.

The predictor 403 reads reference images from the reference memory 407 and generates a prediction image. Then, the predictor 403 sends the generated prediction image to the adder 406.

The adder 406 adds the residual error signal and the prediction image, and generates a decoded image. Herein, the decoded image corresponds to a viewpoint image. The adder 406 writes the decoded image in the reference memory 407.

The output unit 408 reads the decoding image from the reference memory 407, and outputs it.

FIG. 13 is a block diagram illustrating the assignor 402 according to the fourth embodiment. The assignor 402 includes a viewpoint position calculator 421 and a number assignor 422.

The viewpoint position calculator 421 refers to the position information of the viewpoint images that is sent from the decoder 401 and refers to the movement information of the viewpoint image assigned with the base viewpoint number, and calculates the position information of each viewpoint image at each point in time. Then, the viewpoint position calculator 421 sends the calculated viewpoint position to the number assignor 422.

The number assignor 422 assigns reference image numbers to the reference images based on the position information of the viewpoints at each point in time. Then, the number assignor 422 sends, to the predictor 403, reference information that indicates the correspondence relationship between the identification numbers of the reference images and the reference image numbers assigned to those reference images.

Meanwhile, the decoder 401, the assignor 402, the predictor 403, the inverse quantizer 404, the inverse transformer 405, the adder 406, and the output unit 408 can be implemented using a central processing unit (CPU) and a memory used by the CPU. The reference memory 407 can be implemented using a memory used by the CPU or using an auxiliary memory device.

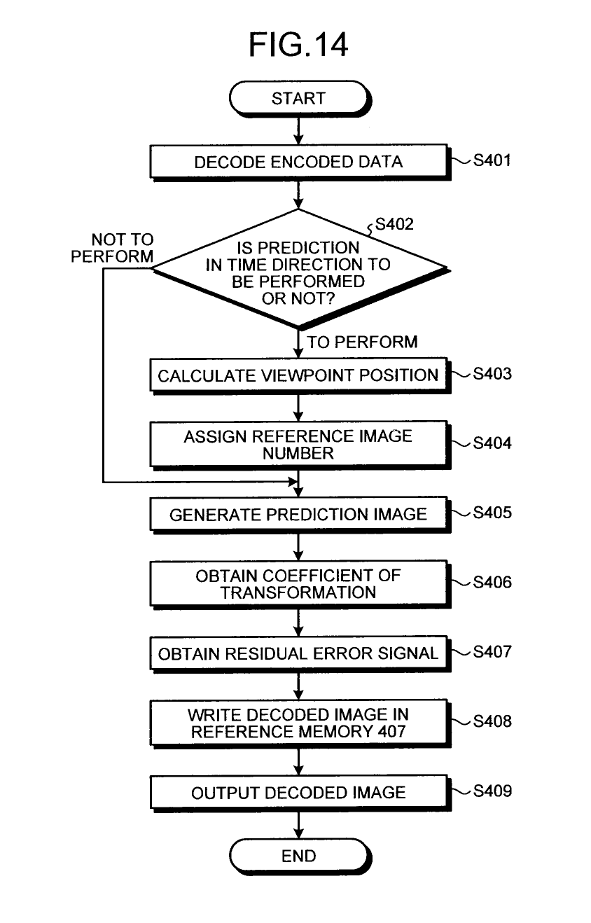

FIG. 14 is a flowchart for explaining the operations performed in the multi-view image decoding device 4. At Step S401, the decoder 401 decodes the input encoded data into residual error information, reference image numbers, position information of viewpoint images, and movement information of the viewpoint image assigned with the base viewpoint number (S401).

At Step S402, the decoder 401 determines whether prediction structure information associated to the decoded viewpoint images indicates “a prediction structure in which prediction in the time direction is not performed” or indicates “a prediction structure in which prediction in the time direction is performed” (S402).

If the prediction structure information indicates “a prediction structure in which prediction in the time direction is performed” (to perform at S402), the decoder 401 sends, to the viewpoint position calculator 421, the position information of the viewpoint images and the movement information of the viewpoint image assigned with the base viewpoint number. Moreover, the decoder 401 sends the residual error information to the inverse quantizer 404. Furthermore, the decoder 401 sends the reference image numbers to the predictor 403. Then, the system control proceeds to Step S403.

On the other hand, if the prediction structure information indicates “a prediction structure in which prediction in the time direction is not performed” (not to perform at S402), the decoder 401 sends the residual error information to the inverse quantizer 404. Moreover, the decoder 401 sends the reference image numbers to the predictor 403. Then, the system control proceeds to Step S405.

At Step S403, the viewpoint position calculator 421 refers to the position information (called Pos(k)) of each viewpoint image sent from the decoder 401 and refers to the movement information Dₜ₁ₜ₀ from the point in time t0 to the point in time t1 of the viewpoint image assigned with the base viewpoint number, and calculates the position (the viewpoint position) of the viewpoint image corresponding to each viewpoint number at each point in time (S403). Herein, the method of calculating the viewpoint positions is identical to the first embodiment.

At Step S404, based on the position information of each viewpoint image at each point in time, the number assignor 422 assigns reference image numbers to the reference images stored in the reference memory 407 (S404). Then, the number assignor 422 sends, to the predictor 403, reference information that indicates the correspondence relationship between the identification numbers of the reference images and the reference image numbers assigned to those reference images. Herein, the method of assigning the reference image numbers is identical to the first embodiment.

At Step S405, the predictor 403 reads reference images from the reference memory 407 and generates a prediction image.

At Step S402, if it is determined “to perform”, the predictor 403 reads the reference images from the reference memory 407 based on the reference order sent from the number assignor 422 and the reference image numbers sent from the decoder 401, and generates a prediction image.

On the other hand, at Step S402, if it is determined “not to perform”, the predictor 403 reads the reference images from the reference memory 407 based on the reference image numbers sent from the decoder 401, and generates a prediction image.

At Step S406, the inverse quantizer 404 performs inverse quantization with respect to the residual error information and obtains a coefficient of transformation (S406).

At Step S407, the inverse transformer 405 performs inverse transformation with respect to the coefficient of transformation, and obtains a residual error signal (S407).

At Step S408, the adder 406 adds the residual error signal sent from the inverse transformer 405 and the prediction image sent from the predictor 403, and generates a decoded image.

At Step S408, the adder 406 writes the decoded image in the reference memory 407 (S408).

At Step S409, the output unit 408 reads the decoded image from the reference memory 407 and outputs it (S409). For example, the output unit 408 can output the decoded image to a display device capable of displaying multi-view images in a stereoscopic manner or to a display device capable of displaying free-viewpoint pictures.

The multi-view image decoding device 4 performs the operations described above in a repeated manner until the input of the encoded data ends.

Till now, the explanation was given about the operations performed in the multi-view image decoding device 4.

According to the fourth embodiment, the multi-view image decoding device 4 can decode the encoded data that has been encoded in the multi-view image encoding device 1 according to the first embodiment or the multi-view image encoding device 2 according to the second embodiment, and can output multi-view images or free-viewpoint images.

### FIFTH EMBODIMENT

A multi-view image decoding device 5 according to a fifth embodiment decodes the encoded data that has been encoded in the multi-view image encoding device 3 according to the third embodiment. Given below is the explanation of the differences with the fourth embodiment.

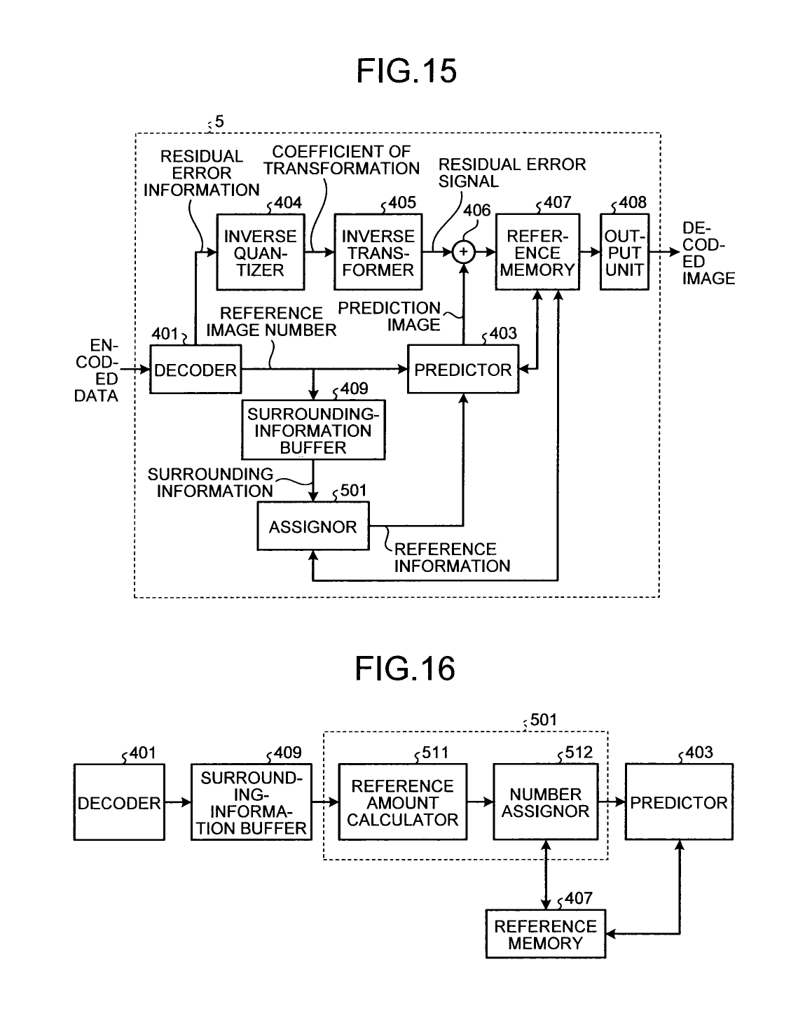

FIG. 15 is a block diagram illustrating the multi-view image decoding device 5. As compared to the multi-view image decoding device 4, the multi-view image decoding device 5 further includes a surrounding-information buffer 409. Moreover, the assignor 402 is replaced with an assignor 501.

As compared to the fourth embodiment, the multi-view image decoding device 5 differs in the way that the decoder 401 sends the reference image numbers to the assignor 501 via the surrounding-information buffer 409. Thus, as compared to the fourth embodiment, the multi-view image decoding device 5 differs in the way that the assignor 501 assigns reference image numbers to the reference images with the use of reference image numbers and surrounding information. Herein, the surrounding information indicates the reference image numbers of the reference images that were used in decoding the already-decoded blocks present around the decoding target block. The surrounding-information buffer 409 is used to store the surrounding information.

The surrounding-information buffer 409 can be implemented using a memory used by the CPU or using an auxiliary memory device.

FIG. 16 is a block diagram illustrating the assignor 501. Herein, the assignor 501 includes a reference amount calculator 511 and a number assignor 512.

The reference amount calculator 511 refers to the surrounding information, counts the number of reference images used as prediction images at the time of decoding the surrounding blocks, and sends the count number to the number assignor 512.

Then, based on the count number sent thereto, the number assignor 512 assigns reference image numbers to the reference images stored in the reference memory 407. The number assignor 512 sends, to the predictor 403, reference information that indicates the correspondence relationship between identification numbers of the reference images and the reference image numbers assigned to those reference images.

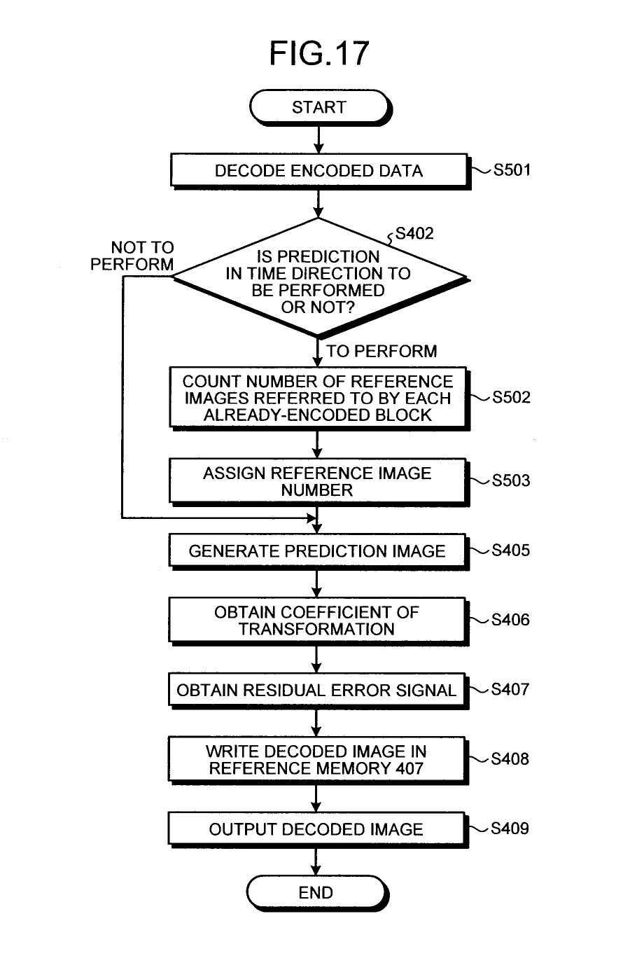

FIG. 17 is a flowchart for explaining the operations performed in the multi-view image decoding device 5. In the flowchart illustrated in FIG. 17, Step S401 illustrated in the flowchart in FIG. 14 is replaced with Step S501. Similarly, Step S403 is replaced with Step S502. Moreover, Step S404 is replaced with Step S503.

At Step S501, the decoder 401 decodes the encoded data into residual error information and reference image numbers (S501).

At Step S502, the reference amount calculator 511 reads the surrounding information from the surrounding-information buffer 409, refers to the reference image numbers of the blocks decoded in the past, and counts the number of reference images that were used in decoding the already-decoded blocks present around the decoding target block (S502). Herein, the method of counting is identical to the third embodiment.

At Step S503, based on the number of counted reference images, reference image numbers are assigned to the reference images (S503). Herein, the method of assigning the reference images number is identical to the third embodiment.

According to the fifth embodiment, it becomes possible to decode the encoded data that has been encoded in the multi-view image encoding device 3 according to the third embodiment, and to output multi-view images or free-viewpoint images.

According to the embodiments described above, it becomes possible to encode and decode multi-view images in an efficient manner.

Meanwhile, the multi-view image encoding method and the multi-view image decoding method according to the embodiments described above can be implemented using, for example, a general-purpose computer device as the basic hardware. Thus, the constituent elements that are supposed be involved in the multi-view image encoding method and the multi-view image decoding method can be implemented by executing programs in a processor installed in the computer device. In that case, the multi-view image encoding method and the multi-view image decoding method can be implemented by installing the programs in advance in the computer device; or by storing the programs in a memory medium such as a CD-ROM or by distributing the programs via a network and then installing them in the computer device. Alternatively, the multi-view image encoding method and the multi-view image decoding method can be implemented using a built-in memory of the computer device or an external memory, a hard disk, or a memory medium such as a CD-R, a CD-RW, a DVD-RAM, or a DVD-R.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirits of the inventions.

What is claimed is:

1. A image encoding device comprising:
an assignor that assigns reference image numbers to reference images according to a number of the reference images used in predicting already-encoded blocks obtained by dividing a viewpoint images included in a mutli-view image;
a predictor that generates a prediction image with respect to an encoding target block obtained by dividing the viewpoint images by referring to the reference images;
a subtractor that calculates a residual error between an encoding target image and the prediction image; and
an encoder that encodes: a coefficient of transformation which is obtained by performing orthogonal transformation and quantization with respect to the residual error; and the reference image numbers of the reference images used in generating the prediction image.

2. The device according to claim 1, wherein the assignor assigns the reference image number in such a manner that, closer a reference image to the encoding target image in terms of a position information, smaller is the reference image number.

3. The device according to claim 1, wherein
the assignor calculates a reference amount by multiplying, to the number of the reference images used in predicting the already-encoded blocks, a weight that increases along with an increase in an area of the already-encoded blocks and that increases along with a decrease in the area of the already-encoded blocks, and assigns the reference image number in such a manner that, greater the reference amount of a reference image, smaller is the reference image number.

4. The device according to claim 1, wherein the assignor assigns the reference image number in such a manner that, greater the number of the reference images, smaller is the number of the reference image number.

5. A multi-view image encoding method for encoding a multi-view image including a plurality of viewpoint images, the method comprising:
assigning, according to a number of reference images used in predicting already-encoded blocks obtained by dividing the viewpoint images, reference image numbers to the reference images;
predicting generating a prediction image with respect to an encoding target block obtained by dividing the viewpoint images by referring to the reference images;
calculating a residual error between an encoding target image and the prediction image; and
encoding a coefficient of transformation which is obtained by performing orthogonal transformation and quantization with respect to the residual error; a position information of the encoding target image; and the reference image numbers of the reference images used in generating the prediction image.

6. The method according to claim 5, wherein
the assigning including
assigning the reference image number in such a manner that, closer a reference image to the encoding target image in terms of a position information, smaller is the reference image number.

7. The method according to claim 5, wherein
the assigning including
calculating a reference amount by multiplying, to the number of the reference images used in predicting the already-encoded blocks, a weight that increases along with an increase in an area of the already-encoded blocks and that increases along with a decrease in the area of the already-encoded blocks, and
assigning the reference image number in such a manner that, greater the reference amount of a reference image, smaller is the reference image number.

8. The method according to claim 5, wherein
the assigning including
assigning the reference image number in such a manner that, greater the number of the reference images, smaller is the number of the reference image number.

9. A image encoding device comprising:
a processor; and
a memory that stores processor-executable instructions that, when executed by the processor, cause the processor to:
assigning, according to a number of reference images used in predicting already-encoded blocks obtained by dividing the viewpoint images, reference image numbers to the reference images;
predicting generating a prediction image with respect to an encoding target block obtained by dividing the viewpoint images by referring to the reference images;
calculating a residual error between an encoding target image and the prediction image; and
encoding a coefficient of transformation which is obtained by performing orthogonal transformation and quantization with respect to the residual error; a position information of the encoding target image; and the reference image numbers of the reference images used in generating the prediction image.

10. The device according to claim 9, wherein
the assigning including
assigning the reference image number in such a manner that, closer a reference image to the encoding target image in terms of a position information, smaller is the reference image number.

11. The device according to claim 9, wherein
the assigning including
calculating a reference amount by multiplying, to the number of the reference images used in predicting the already-encoded blocks, a weight that increases along with an increase in an area of the already-encoded blocks and that increases along with a decrease in the area of the already-encoded blocks, and
assigning the reference image number in such a manner that, greater the reference amount of a reference image, smaller is the reference image number.

12. The device according to claim 9, wherein
the assigning including
assigning the reference image number in such a manner that, greater the number of the reference images, smaller is the number of the reference image number.
